(19) United States
(12) Patent Application Publication
(10) Pub. No.: US 2014/0300790 A1
(43) Pub. Date: Oct. 9, 2014

(54) IMAGE PROCESSING APPARATUS, AND NON-TRANSITORY COMPUTER READABLE MEDIUM STORING IMAGE PROCESSING PROGRAM

(71) Applicant: Fuji Xerox Co., Ltd., Tokyo (JP)

(72) Inventors: Tetsuya WAKIYAMA, Kanagawa (JP); Hiromi KITA, Kanagawa (JP); Katsuya KOYANAGI, Kanagawa (JP); Junichi SHIMIZU, Kanagawa (JP); Shintaro ADACHI, Kanagawa (JP); Hiroyuki KISHIMOTO, Kanagawa (JP)

(73) Assignee: FUJI XEROX CO., LTD., Tokyo (JP)

(21) Appl. No.: 14/095,094

(22) Filed: Dec. 3, 2013

(30) Foreign Application Priority Data
Apr. 4, 2013 (JP) 2013-078504

(51) Int. Cl. H04N 5/232

(52) U.S. Cl. CPC H04N 5/23293
USPC 348/333.01

(57) ABSTRACT

Provided is an image processing apparatus including a determination unit that determines a partial region which is a display object in an image, an angle acquisition unit that acquires angle information indicating a tilt in the partial region, a correction unit that corrects an angle of the partial region according to the angle information, and a display that displays a partial region of which the angle is corrected.

### CROSS-REFERENCE TO RELATED APPLICATIONS

This application is based on and claims priority under 35 USC 119 from Japanese Patent Application No. 2013-078504 filed Apr. 4, 2013.

### BACKGROUND

(i) Technical Field

The present invention relates to an image processing apparatus, and a non-transitory computer readable medium storing an image processing program.

(ii) Related Art

When a document is read with an image reader such as a scanner or a camera, and thus an image is acquired, the image is tilted as compared with the original document in some cases. For this reason, a technique for correcting tilt of an image has been developed in the related art.

In a technique for correcting tilt, employed in the related art, only one tilt angle is detected from an image, and the entire image is corrected using the tilt angle. For example, when a bound original document is read on double-spread pages, since tilt angles are different in the double-spread pages or the original document is curved at the bound location, the bound original document is thus read so as to be further tilted than the outside thereof, and a tilt angle varies in the image. In addition, when several images are combined as well, a tilt angle may be different for each image. In this case, only one tilt angle may not be obtained, or it is unclear whether or not a corrected image is a correction result desired by a user even if the entire image is corrected using only one tilt angle.

In addition, an erroneously detected tilt angle is unable to be handled, and, even if a region on which tilt correction is desired by a user is limited, the tilt correction is performed on the entire image. In addition, some tilt correction is performed even on a region, such as a handwritten region on which tilt correction is not required to be performed.

### SUMMARY

According to an aspect of the invention, there is provided an image processing apparatus including:

a determination unit that determines a partial region which is a display object in an image;

an angle acquisition unit that acquires angle information indicating a tilt in the partial region;

a correction unit that corrects an angle of the partial region according to the angle information; and

a display that displays a partial region of which the angle is corrected.

### BRIEF DESCRIPTION OF THE DRAWINGS

Exemplary embodiments of the present invention will be described in detail based on the following figures, wherein:

FIG. 1 is a configuration diagram illustrating a first exemplary embodiment of the invention;

FIGS. 2A to 2C are diagrams illustrating a specific example in the first exemplary embodiment of the invention;

FIG. 3 is a diagram illustrating an example of a display screen when a partial region is designated;

FIG. 4 is a configuration diagram illustrating a second exemplary embodiment of the invention;

FIGS. 5A and 5B are diagrams illustrating a specific example in the second exemplary embodiment of the invention;

FIGS. 6A and 6B are diagrams illustrating a specific example in a modification example of the second exemplary embodiment of the invention;

FIG. 7 is a configuration diagram illustrating a third exemplary embodiment of the invention;

FIG. 8 is a flowchart illustrating an example of an operation in the third exemplary embodiment of the invention;

FIGS. 9A to 9C are diagrams illustrating a specific example in the third exemplary embodiment of the invention; and

FIG. 10 is a diagram illustrating an example of a computer program, a storage medium storing the computer program, and a computer when functions described in the respective exemplary embodiments and modification examples are realized using the computer program.

### DETAILED DESCRIPTION

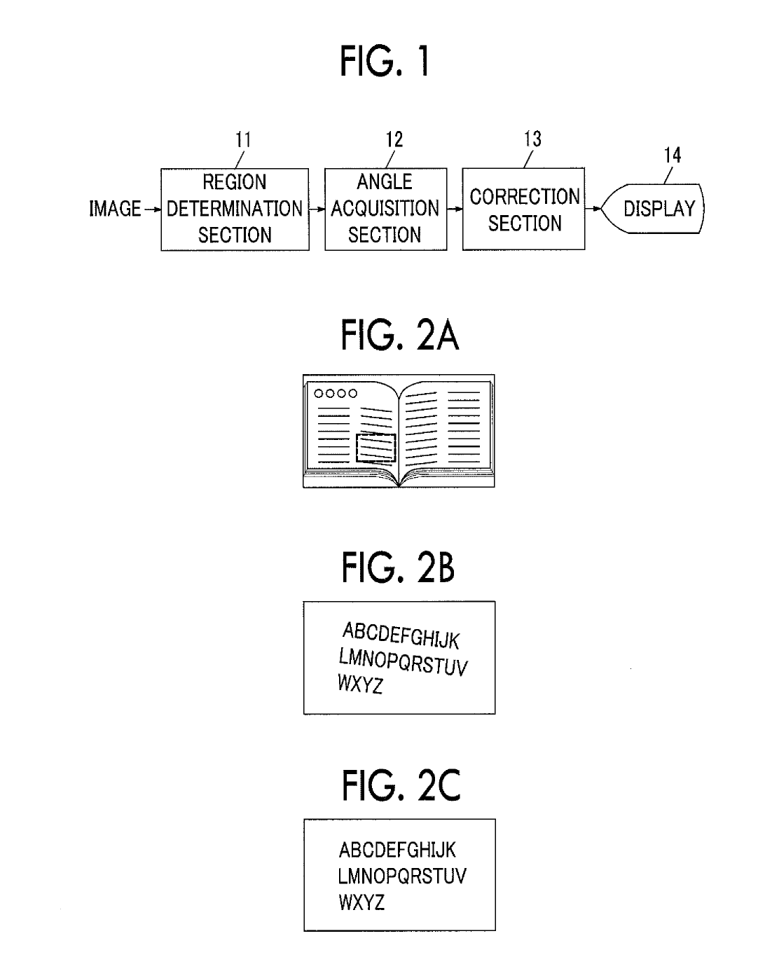

FIG. 1 is a configuration diagram illustrating a first exemplary embodiment of the invention. In FIG. 1, the reference numeral 11 indicates a region determination section, the reference numeral 12 indicates an angle acquisition section, the reference numeral 13 indicates a correction section, and the reference numeral 14 indicates a display. The region determination section 11 determines a partial region which is a display object in an image. For example, an image may be displayed on the display 14, and a partial region may be determined by receiving a designation of a display region by a user, or the like.

The angle acquisition section 12 acquires angle information indicating a tilt in the partial region determined by the region determination section 11. For example, a tilt angle of the partial region may be calculated using a well-known method such as a Hough transform, and may be used as the angle information.

The correction section 13 at least corrects an angle of the partial region determined by the region determination section 11 according to the angle information acquired by the angle acquisition section 12. This process may also be performed using a well-known tilt correction method. A correction process may not be performed on regions other than the partial region, or tilt correction may be performed thereon according to the angle information acquired for the partial region.

The display 14 displays the partial region of which an angle is corrected by the correction section 13. In this case, regions other than the partial region may not be displayed, or may be displayed when tilt correction is performed thereon by the correction section 13.

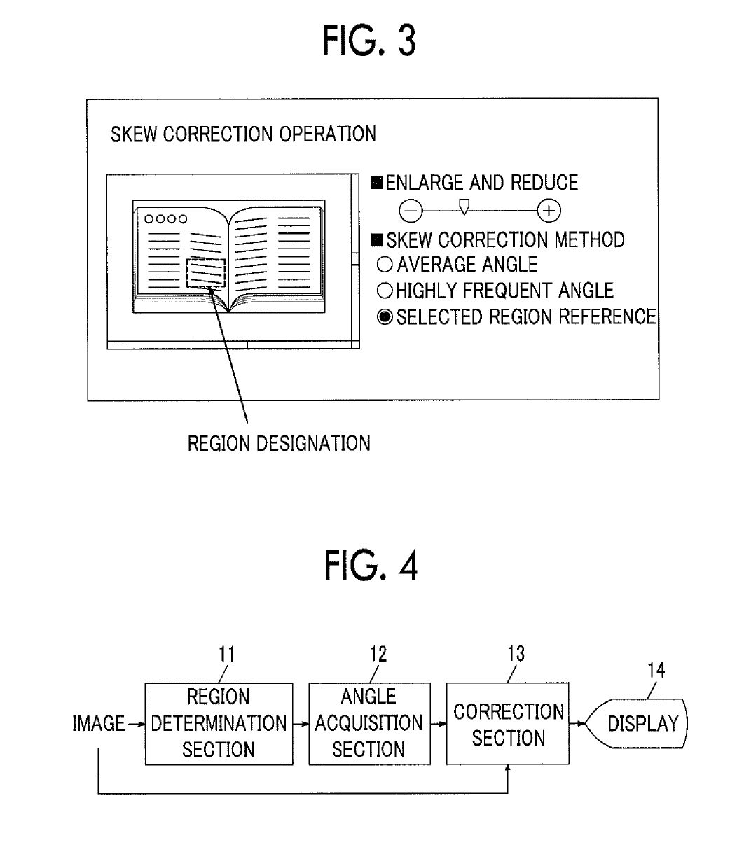

FIGS. 2A to 2C are diagrams illustrating a specific example in the first exemplary embodiment of the invention, and FIG. 3 is a diagram illustrating an example of a display screen when a partial region is designated. FIG. 2A illustrates an example of a given image. In this example, a case where a book or the like with double-spread pages is read with an image reader is assumed, and thus the bound part thereof is curved. When tilt correction is performed on this image, the curved part has a smaller proportion than other parts, and thus tilt correction corresponding to the curved part is not performed.

In this image, a user designates a partial region so as to enlarge and display an image including the curved part surrounded by the broken line. For example, an image may be displayed as illustrated as an example in FIG. 3, and a partial region may be designated. At this time, a “selected region reference” item is selected as a “skew correction method”. When this item is selected, designation of a partial region may be received. A method of designating a partial region may be any one of various well-known methods. A partial region may be designated using various methods such as, for example, dragging with a mouse or extracting an object including a touched point.

When the partial region is designated by the user, the region determination section 11 receives the designation so as to determine the partial region. This partial region is illustrated in FIG. 2B. Each row is skewed in the partial region, and this tilt angle is acquired as the angle information by the angle acquisition section 12. In addition, a tilt correction process is performed according to the acquired angle information by the correction section 13, and a corrected image is enlarged and displayed on the display 14. The displayed image is illustrated in FIG. 2C. The entire image illustrated in FIG. 2A is not tilted and thus a correction process is not performed in the related art, but a tilt occurs in the partial region, and the tilt is corrected. Accordingly, as illustrated in FIG. 2C, a tilt-corrected image is displayed.

FIG. 4 is a configuration diagram illustrating a second exemplary embodiment of the invention. A description will be made based mainly on a part different from the first exemplary embodiment. The region determination section 11, the angle acquisition section 12, and the display 14 are the same as described in the first exemplary embodiment, but the correction section 13 in the second exemplary embodiment corrects a tilt angle of an entire image according to angle information acquired from a partial region by the angle acquisition section 12. In addition, an image of which the tilt angle has been corrected is displayed on the display 14. Alternatively, a corrected image may be preserved, or may be transmitted to other devices or processing units.

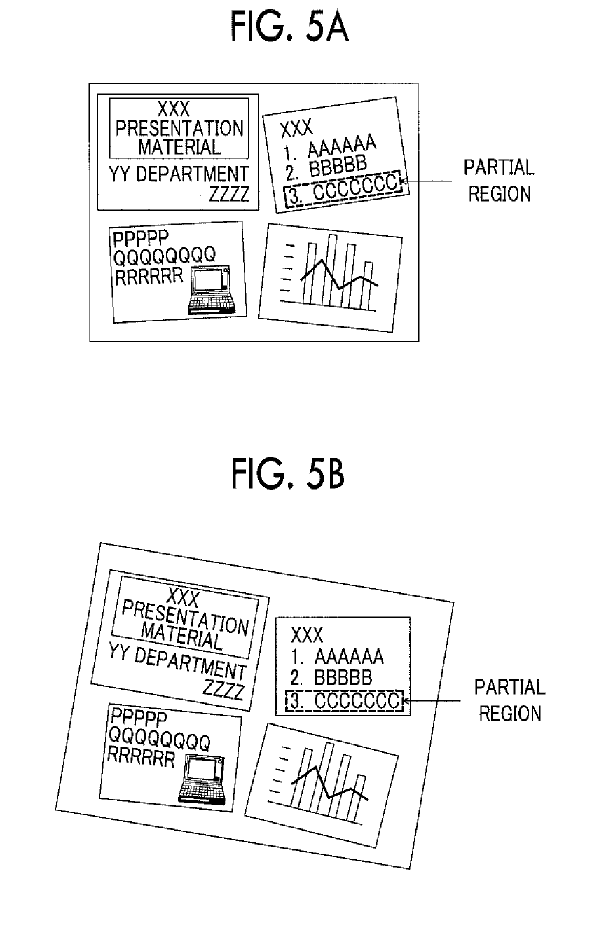

FIGS. 5A and 5B are diagrams illustrating a specific example in the second exemplary embodiment of the invention. FIG. 5A illustrates an example of a given image. This example corresponds to a case where documents of four pages are collected on a single image, and a tilt angle is different for each page.

A case where a user refers to the region surrounded by the bold broken line in this image is assumed. In this case, the user designates the region surrounded by the bold broken line, and the designation is received by the region determination section 11, and the region is designated as a partial region. In addition, a tilt angle of the partial region is acquired as angle information by the angle acquisition section 12. The correction section 13 performs an angle correction process on the entire image according to the angle information acquired by the angle acquisition section 12, and displays a corrected image on the display 14. Further, when the image is displayed, display for easy understanding when viewed, such as highlight display or comment display, may be performed in the partial region determined as a reference for the correction by the region determination section 11.

FIG. 5B illustrates an example of a displayed image. At least the designated partial region has corrected tilt, and is thus more easily referred to than before being corrected. In a method of the related art of calculating a tilt angle from an entire image, what kind of tilt correction process is performed on the image may not be known, and a region which is referred to may be more tilted. In the second exemplary embodiment of the invention, a tilt of at least a region which is indicated by a user is corrected, and thus display desired by the user may be obtained.

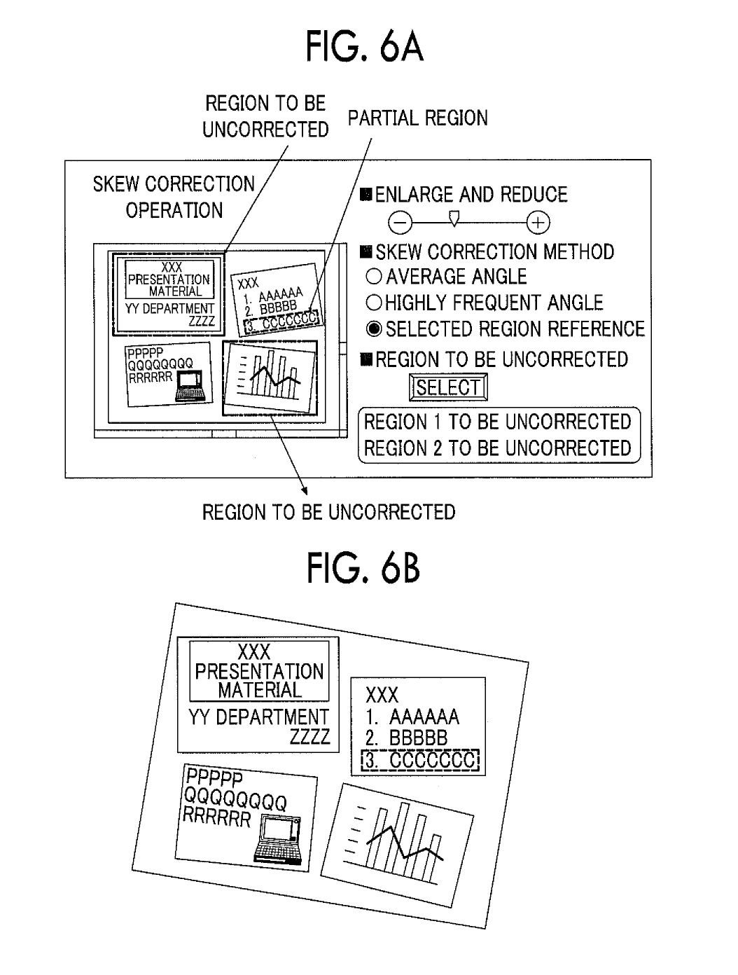

As a modification example of the second exemplary embodiment of the invention, there may be a configuration in which the region determination section 11 receives designation of a region to be uncorrected on which angle correction will not be performed, and the correction section 13 does not perform angle correction on the region to be uncorrected. FIGS. 6A and 63 are diagrams illustrating a specific example in a modification example of the second exemplary embodiment of the invention. FIG. 6A illustrates an example of a display screen when a user designates a partial region which is used as a reference for tilt correction in a case where the image illustrated in FIG. 5A is given. The example of the screen corresponds to a case where the “skew correction method” illustrated in FIG. 3 is selected, a partial region indicated by the broken line is designated, and a “region to be uncorrected” item is provided. For example, when a user designates a region and manipulates the “select” button, the designated region is received as a region to be uncorrected. The designated region to be uncorrected is indicated by the dot chain line. In this example, two regions to be uncorrected are designated.

If the region determination section 11 receives designation of the partial region which is used as a reference for tilt correction and the region to be uncorrected on which tilt correction is not performed, the angle acquisition section 12 calculates a tilt angle in the partial region so as to acquire angle information. The correction section 13 performs the angle correction process on the entire image according to the angle information acquired by the angle acquisition section 12, but does not perform the correction process on the region to be uncorrected at this time.

An example of an image obtained through the correction process is illustrated in FIG. 6B. The tilt correction is performed on the entire image according to an angle with which the designated partial region is tilted, but the correction process is not performed on the region designated as a region to be uncorrected, and thus the original image remains intact. In this example, a region with a tilt smaller than the partial region in the uncorrected image is designated as a region to be uncorrected so as to be prevented from being tilted due to the tilt correction. In addition, a region of which a tilt angle may not be corrected, such as, for example, a region which is intentionally described so as to be tilted, or a region which is not originally described linearly, such as a handwritten region, may be designated as a region to be uncorrected.

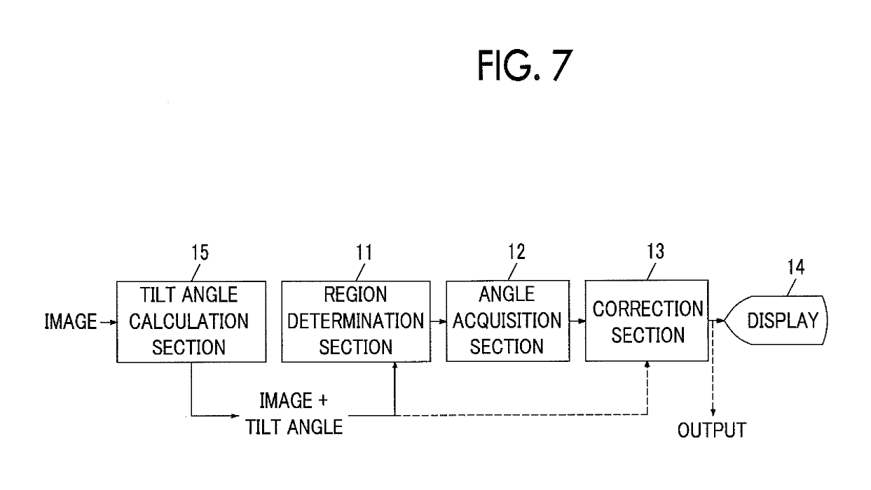

FIG. 7 is a configuration diagram illustrating a third exemplary embodiment of the invention. In FIG. 7, the reference numeral 15 indicates a tilt angle calculation section. In the third exemplary embodiment, a description will be made of an example in which a tilt angle is calculated in advance.

The tilt angle calculation section 15 calculates a tilt angle for each divided region of an image. An image may be divided into regions with a predefined size, or may be divided using various well-known methods such as a method of dividing an image in a white region. A tilt angle is calculated for each divided region by using a well-known method such as, for example, a Hough transform, and is correlated with each divided region.

The process by the tilt angle calculation section 15 may be performed in advance, and may not be provided when a tilt correction process is performed. For example, when an image in which a tilt angle is correlated with each divided region is given, the tilt angle calculation section 15 may not be provided.

The region determination section 11 determines a partial region which is a display object in the image, for example, in response to an instruction or the like from a user as described in the first and second exemplary embodiments. In addition, a region to be uncorrected described in the modification example of the second exemplary embodiment may be set.

The angle acquisition section 12 specifies a divided region included in the partial region determined by the region determination section 11, and acquires angle information from a tilt angle corresponding to the divided region. For example, when a single divided region is included in a partial region, or a divided region is partially designated as a partial region, a tilt angle corresponding to the divided region may be acquired as angle information. When a tilt angle is calculated in advance, the angle acquisition section 12 may not calculate a tilt angle again. When a partial region includes two or more divided regions, tilt angles which respectively correspond to the two or more divided regions are read, and angle information is acquired from the tilt angles. A method of acquiring angle information may be selected from various well-known methods such as, for example, an average value of plural tilt angles, a weighted average depending on the area, and a majority rule.

The correction section 13 performs the angle correction process on at least the partial region which is determined by the region determination section 11 as described in the first exemplary embodiment, according to the angle information acquired by the angle acquisition section 12, or performs the angle correction process on the entire image as described in the second exemplary embodiment. Of course, when a region to be uncorrected described in the modification example of the second exemplary embodiment is set, correction may not be performed on the region to be uncorrected. An image or a partial image corrected by the correction section 13 is displayed on the display 14. Alternatively, the corrected image may be preserved, or may be transmitted to other devices or processing units. In addition, if the tilt angle information is not necessary after the correction process, the tilt angle information correlated with each divided region may be deleted.

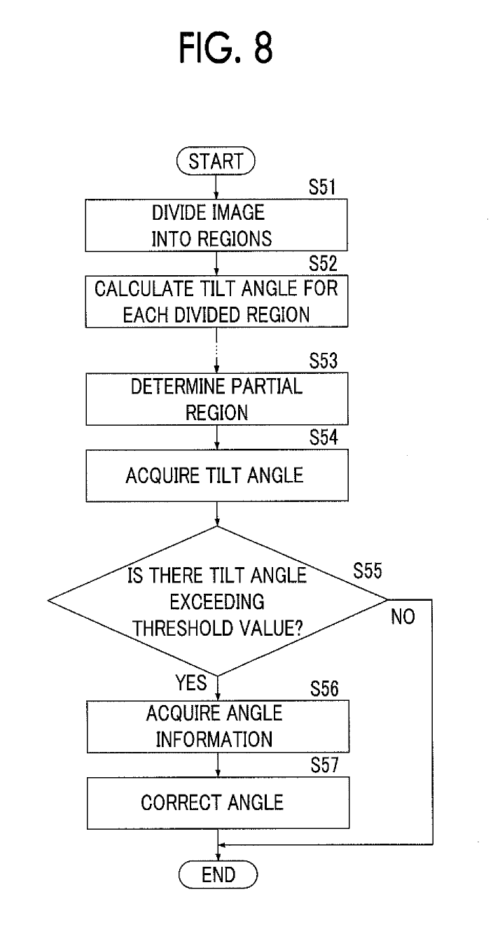

FIG. 8 is a flowchart illustrating an example of an operation in the third exemplary embodiment of the invention. In step S51, the tilt angle calculation section 15 divides a given image into plural regions. In addition, in step S52, a tilt angle is calculated for each divided region, and is correlated therewith.

In step S53, the region determination section 11 determines a partial region, for example, in response to an instruction or the like from a user. In addition, instep S54, a tilt angle corresponding to a divided region included in the partial region determined in step S53 is acquired.

This operation example illustrates an example of a case where correction of a tilt angle is not performed if there is no tilt angle exceeding a predefined threshold value. Instep S55, it is determined whether or not there is an angle exceeding the predefined threshold value in the tilt angle acquired in step S54. If there is no angle exceeding the predefined threshold value in the tilt angle acquired in step S54, the correction process of the tilt angle is not performed by the correction section 13, and an image of the partial region or the given image is displayed, for example, on the display 14 or is output to an external device, thereby finishing the process. There is a case where the correction process is wasteful since a user does not become aware even if correction is performed depending on a tilt angle, and the correction process is omitted in this case. Of course, this process may be performed based on the first exemplary embodiment, the second exemplary embodiment, and the modification example thereof, or, conversely, this determination may not be performed.

If it is determined in step S55 that there is an angle exceeding the predefined threshold value in the tilt angle acquired in step S54, in step S56, the angle acquisition section 12 acquires angle information on the basis of the tilt angle acquired in step S54. In the third exemplary embodiment, the tilt angle is calculated in advance in step S52, and thus the tilt angle is not calculated when the angle information is acquired in step S56. Therefore, processes subsequent to the determination of the partial region in step S53 are performed at a higher speed than in a case where a tilt angle is calculated when angle information is acquired.

In addition, in step S57, the correction section 13 performs a process of correcting an angle of the partial region or the entire image according to the angle information acquired in step S56. Of course, if a region to be uncorrected described in the modification example of the second exemplary embodiment is set, angle correction is not performed on the region to be uncorrected.

A corrected image or a corrected partial image is displayed on the display 14. Alternatively, the corrected image or the corrected partial image may be preserved, or may be output to an external device, for example, by being forwarded to other software circuits or other devices.

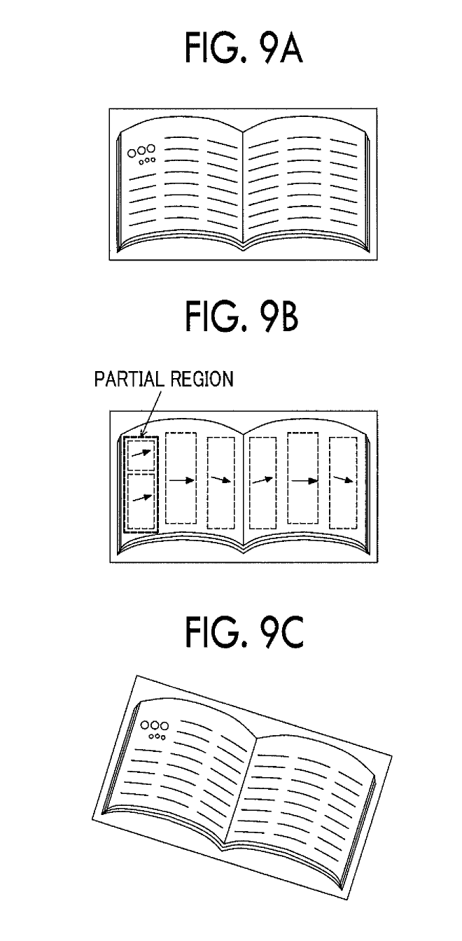

FIGS. 9A to 9C are diagrams illustrating a specific example in the third exemplary embodiment of the invention. FIG. 9A illustrates an example of a given image. This example illustrates an example of an image in which a document is read in a curved state, and a tilt angle is different for each column among multiple columns. The tilt angle calculation section 15 divides this image along white regions so as to obtain divided regions. Each divided region is indicated by being surrounded by the broken line in FIG. 9B. In addition, the tilt angle calculation section 15 calculates a tilt angle for each divided region so as to correlate the calculated tilt angle therewith. In FIG. 93, the calculated tilt angle is indicated by the arrow in each divided region.

When a user designates the region surrounded by the bold broken line of FIG. 9B in this image, the region determination section 11 determines the designated region as a partial region. The angle acquisition section 12 acquires angle information from the tilt angles corresponding to the divided regions included in the partial region, in this example, two divided regions. The angle information may be acquired using various methods such as, for example, using an average of the two tilt angles or selecting a tilt angle with a larger value.

The correction section 13 performs, in this example, the angle correction process on the entire image according to the angle information acquired by the angle acquisition section 12. FIG. 9C illustrates an example of a processed image. The partial region indicated by the user has the corrected tilt and is thus more easily viewed than before being corrected.

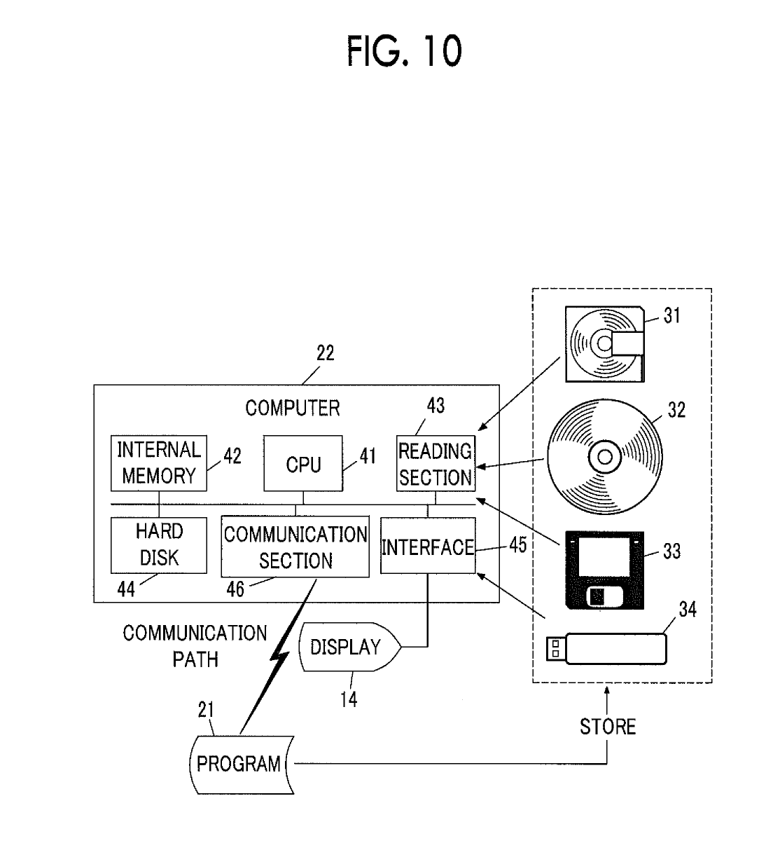

FIG. 10 is a diagram illustrating an example of a computer program, a storage medium storing the computer program, and a computer when functions described in the respective exemplary embodiments and modification examples are realized using the computer program. In FIG. 10, the reference numeral 21 indicates a program, the reference numeral 22 indicates a computer, the reference numeral 31 indicates a magnetooptical disc, the reference numeral 32 indicates an optical disc, the reference numeral 33 indicates a magnetic disk, the reference numeral 34 indicates a memory, the reference numeral 41 indicates a CPU, the reference numeral 42 indicates an internal memory, the reference numeral 43 indicates a reading section, the reference numeral 44 indicates a hard disk, the reference numeral 45 indicates an interface, and the reference numeral 46 indicates a communication section.

All or some of the functions of the respective sections described in the above-described exemplary embodiments and modification examples of the invention may be realized by the program 21 executed by the computer. In this case, the program 21, data used by the program, and the like may be stored in the storage medium which is read by the computer. The storage medium causes a variation state of energy such as magnetism, light, or electricity in the reading section 43 provided in hardware resources of the computer according to content of the program, and forwards the content of the program to the reading section 43 in a form of a signal corresponding thereto. The magnetooptical disc 31, the optical disc 32 (including a CD, a DVD, or the like), the magnetic disk 33, the memory 34 (including an IC card, a memory card, a flash memory, or the like), and the like are examples of the storage medium. Of course, these storage media are not limited to a portable type.

The program 21 is stored in the storage medium, the storage medium is installed, for example, in the reading section 43 or the interface 45 of the computer 22, the program 21 is read from the computer so as to be stored in the internal memory 42 or the hard disk 44 (including a magnetic disk, a silicon disk, or the like) , and the CPU 41 executes the program 21, thereby realizing all or some of the functions described in the above-described respective exemplary embodiments and modification examples of the invention. Alternatively, the program 21 may be transmitted to the computer 22 via a communication path, the program 21 may be received by the communication section 46 in the computer 22 so as to be stored in the internal memory 42 or the hard disk 44, and the CPU 41 may execute the program 21, thereby realizing the functions.

In addition, hardware configuring the display 14 may be connected to the computer via the interface 45. The computer 22 may be connected to other various devices via the interface 45. For example, a reception unit which receives a designation or the like of a region performed by a user may be connected thereto, and thus an indication of a partial region or a region to be uncorrected or a selection of the option in the example of the screen illustrated in FIG. 3 or FIGS. 6A and 6B may be performed by a user. Of course, other devices may be connected thereto via the interface 45. Further, the respective constituent elements are not required to be operated in a single computer, and processes may be performed in other computers according to a process step.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image processing apparatus comprising:
a determination unit that determines a partial region which is a display object in an image;
an angle acquisition unit that acquires angle information indicating a tilt in the partial region;
a correction unit that corrects an angle of the partial region according to the angle information; and
a display that displays a partial region of which the angle is corrected.

2. An image processing apparatus comprising:
a determination unit that determines a partial region in an image;
an angle acquisition unit that acquires angle information indicating a tilt in the partial region; and
a correction unit that corrects an angle of the entire image according to the angle information.

3. The image processing apparatus according to claim 2, wherein
the determination unit receives a designation of a region to be uncorrected on which angle correction is not performed, and the correction unit does not perform the angle correction on the region to be uncorrected.

4. The image processing apparatus according to claim 1, further comprising:
a calculation unit that calculates a tilt angle for each divided region obtained by dividing the image,
wherein the angle acquisition unit acquires the angle information based on a tilt angle corresponding to a divided region included in the partial region.

5. The image processing apparatus according to claim 2, further comprising:
a calculation unit that calculates a tilt angle for each divided region obtained by dividing the image,
wherein the angle acquisition unit acquires the angle information based on a tilt angle corresponding to a divided region included in the partial region.

6. The image processing apparatus according to claim 3, further comprising:
a calculation unit that calculates a tilt angle for each divided region obtained by dividing the image,
wherein the angle acquisition unit acquires the angle information based on a tilt angle corresponding to a divided region included in the partial region.

7. The image processing apparatus according to claim 1, wherein
a tilt angle is correlated with each divided region in the image, and
the angle acquisition unit acquires the angle information based on a tilt angle corresponding to a divided region included in the partial region.

8. The image processing apparatus according to claim 2, wherein
a tilt angle is correlated with each divided region in the image, and
the angle acquisition unit acquires the angle information based on a tilt angle corresponding to a divided region included in the partial region.

9. The image processing apparatus according to claim 3, wherein
a tilt angle is correlated with each divided region in the image, and
the angle acquisition unit acquires the angle information based on a tilt angle corresponding to a divided region included in the partial region.

10. A non-transitory computer readable medium storing an image processing program causing a computer to execute the function of the image processing apparatus according to claim 1.

11. A non-transitory computer readable medium storing an image processing program causing a computer to execute the function of the image processing apparatus according to claim 2.

12. The image processing apparatus according to claim 1, wherein
the angle information is obtained by a Hough transform.

13. The image processing apparatus according to claim 2, wherein
the angle information is obtained by a Hough transform.
